(19) United States
(12) Patent Application Publication
(10) Pub. No.: US 2005/0079869 A1
(43) Pub. Date: Apr. 14, 2005

(54) Mobile node authentication

(75) Inventors: Mohamed Khalil, Murphy, TX (US); Kuntal Chowdhury, Plano, TX (US); Haseeb Akhtar, Garland, TX (US)

Correspondence Address: TROP PRUNER & HU, PC, 8554 KATY FREEWAY, SUITE 100, HOUSTON, TX, 77024, US

(73) Assignee: Nortel Networks Limited, St. Laurent (CA)

(21) Appl. No.: 10/958,819

(22) Filed: Oct. 5, 2004

Related U.S. Application Data
(60) Provisional application No. 60/510,607, filed on Oct. 13, 2003.

(51) Int. Cl. H04Q 7/20

(52) U.S. Cl. 455/435.1; 455/411

(57) ABSTRACT

To authenticate a mobile node, a Mobile IPv6 registration request is received from the mobile node, where the registration request contains authentication information. One example of the Mobile IPv6 registration request is a Mobile IPv6 Binding Update message. A procedure to authenticate the mobile node is performed based on the authentication information contained in the registration request.

### CROSS-REFERENCE TO RELATED APPLICATION

This claims the benefit under 35 U.S.C. § 119(e) of U.S. Provisional Application Ser. No. 60/510,607, entitled “Mobile IPv6 Authentication and Authorization,” filed Oct. 13, 2003, which is hereby incorporated by reference.

### TECHNICAL FIELD

The invention relates generally to mobile node authentication.

### BACKGROUND

Packet-based data networks are widely used to link various types of network elements, such a personal computers, network telephones, Internet appliances, personal digital assistants (PDAs), mobile telephones, and so forth. Many types of communications are possible over packet-based data networks, including electronic mail, web browsing, file downloads, electronic commerce transactions, voice or other forms of real-time, interactive communications, and so forth.

One type of a packet-based network is an Internet Protocol (IP)-based network. Communications over a packet-based network is performed using packets or datagrams that are typically sent in bursts from a source to one or more destination points. A network element is typically assigned a network address (e.g., an IP address). A packet sent across a data network includes a source network address (of the source network element) and a destination network address (of the destination network element). Routers in the data network route each packet over network paths based on the source and destination addresses. Such communications over packet-based networks are referred to as packet-switched communications.

Mobility of network elements (such as notebook computers or PDAs) is a desired feature. As a user travels between different points, the point of attachment of the network element associated with the user may change. The user can potentially move from his or her home network (first point of attachment) to another network, referred to as a visited or foreign network (second point of attachment). The point of attachment of a mobile network element to a network can either be a wired attachment or wireless attachment. An example of a wired attachment is using a network cable to connect the mobile network element to a port in a wall outlet that connects to a network. An example of a wireless point of attachment is a wireless link between a mobile station and a base station of a mobile communications network (such as a cellular communications network). In the latter case, the mobile station can be a mobile telephone or any other portable device that is capable of communicating wireless signaling with base stations associated with the mobile communications network.

To provide enhanced flexibility and convenience in allowing a user to change points of attachment across different networks, the Mobile IP protocol has been defined. One version of Mobile IP is Mobile IPv6. The Mobile IP protocol defines a home agent, which is a router in the home network of a mobile network element that is responsible for tunneling packets for delivery to the mobile network element when it is away from the home network. The home agent maintains the current location information for the mobile network element. The Mobile IP protocol also defines a foreign agent, which is a router in the visited or foreign network that the mobile network element is currently attached to. The foreign agent provides routing services to the mobile network element, and detunnels and delivers packets to the mobile network element that were tunneled by the mobile network element's home agent.

A concern associated with use of a mobile node that can traverse different networks is authentication of the mobile node. The base specification of Mobile IPv6, mandates that the IP Security (IPsec) protocol be used between a mobile node and a home agent for authentication of the mobile node. Although IPsec may offer relatively strong protection, the implementation of IPsec may not be practical in all cases. For example, IPsec is processing intensive; as a result, in small handheld devices, IPsec may consume a relatively large portion of the available processing capacity of such a device. A further concern with such devices is the fact that the power available from the battery may be limited, and the processing load placed by IPsec may cause relatively quick depletion of the available battery capacity.

The authentication mechanism using IPsec is based on the home IP address of the mobile node. Therefore, using IPsec may prevent the mobile node from acquiring a dynamic home address. Moreover, in some cases, when the mobile node initially starts up in a network, such as a visited network, the mobile node may not be aware of its IP address. Consequently, the mobile node would not have an available IP address for executing the IPsec authentication mechanism.

### SUMMARY

In general, methods and apparatus are provided to efficiently authenticate a mobile node. For example, a method of authenticating a mobile node comprises receiving, from the mobile node, a Mobile IPv6 registration request that contains authentication information. A procedure is performed to authenticate the mobile node based on the authentication information contained in the registration request. A reply is sent to the mobile node acknowledging successful registration.

Other or alternative features will become apparent from the following description, from the drawings, and from the claims.

### BRIEF DESCRIPTION OF THE DRAWINGS

FIG. 1 is a block diagram of an example arrangement of a mobile communications network having a home network and a visited or foreign network, in which an authentication mechanism according to some embodiments is implemented.

FIG. 2 is a message flow diagram of a process of authenticating a mobile node, in accordance with an embodiment.

FIGS. 3-5 illustrate formats of several messages according to some embodiments.

### DETAILED DESCRIPTION

In the following description, numerous details are set forth to provide an understanding of some embodiments. However, it will be understood by those skilled in the art that embodiments may be practiced without these details and that numerous variations or modifications from the described embodiments may be possible.

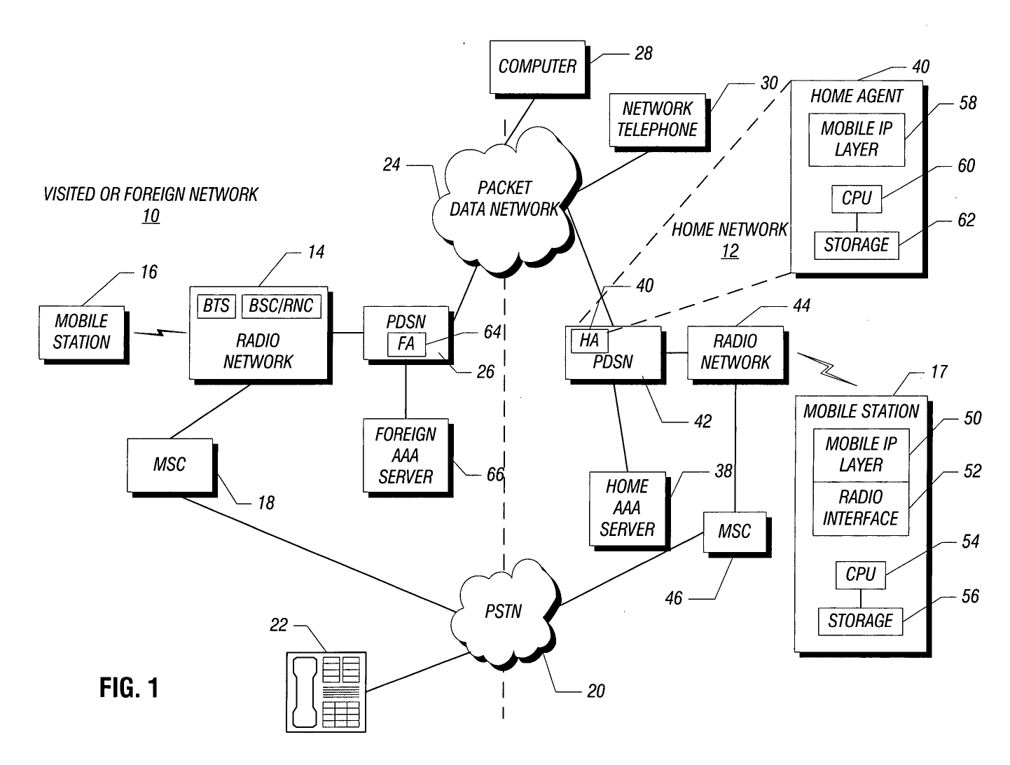

FIG. 1 illustrates an example arrangement of a wireless mobile communications network that includes a first wireless network 10 and a second wireless network 12. Each wireless network includes an arrangement of cells, with each cell having a radio base station to communicate radio frequency (RF) signals with mobile stations (e.g., mobile telephones). The two wireless networks may be associated with different service providers.

Note that the arrangement shown in FIG. 1 is an example of a mobile or wireless communications network that is implemented according to the code-division multiple access (CDMA) 2000 family of standards. The CDMA 2000 standards were developed by the Third Generation Partnership Project 2 (3GPP2). A CDMA 2000 wireless network is capable of supporting both circuit-switched services and packet-switched services.

Other types of mobile communications networks can be employed in other embodiments, such as those networks based on time-division multiple access (TDMA) protocols. One example of a TDMA protocol that supports packet-switched services is the UMTS (Universal Mobile Telecommunications System) standard. The wireless protocols that support packet-switched services referred to here are provided as examples only, as other protocols can be used in other embodiments.

Other wireless technologies to which some embodiments can be applied include IEEE 802.11a, Wideband CDMA (WCDMA), General Packet Radio Service (GPRS), Global System for Mobile (GSM), and so forth. As noted above, the concept of mobility can also be applied to wired networks instead of wireless networks.

Mobility can also be provided in a wired communications network arrangement, in which mobile network elements are attached to a network by a wired connection. A wired connection is usually in the form of a direct cable connection between the mobile network element and the respective network. Alternatively, a wired connection arrangement can also include a wireless local area network (LAN), in which the mobile network element communicates wirelessly with base stations that are in close proximity to the mobile network element, with the base stations being wired to the network. The concepts described herein for authenticating a mobile node in a network are applicable to either a wireless mobile communications network arrangement (such as CDMA or TDMA wireless network arrangement or a wireless LAN arrangement) or to a wired network arrangement. In the wired context, the home network 12 represents one domain while the foreign network 10 represents another domain. Instead of radio networks, mobile nodes access each network through a wired connection.

In the ensuing discussion, a “mobile node” or “mobile station” refers to a mobile node or mobile station that is either a wireless or wired node.

As shown in FIG. 1, from the perspective of a given mobile station 16, the mobile communications network includes a home network 12 and a visited or foreign network 10. The mobile station 16 is associated with a subscriber of the service provider that supports the home network 12. However, the mobile station 16 can travel to a location that is covered by the visited wireless network 10. From the perspective of other mobile stations, the network 10 is the home network while the network 12 is potentially a visited or foreign network.

FIG. 1 shows that the mobile station 16 has traveled outside the coverage area of the home wireless network 12 and into the foreign wireless network 10. However, note that another mobile station 17 has remained in its home wireless network. The foreign wireless network 10 includes a radio network 14, which includes plural base transceiver systems (BTS) and radio network controllers (RNCs) or base station controllers (BSCs) that control radio communications in respective cells or cell sectors. Once attached to the foreign wireless network 10, the mobile station 16 is able to communicate control signaling and traffic over radio frequency (RF) signals or other wireless signals with the radio network 14. The home network 12 similarly also includes a radio network 44 that provides an air interface to the mobile station 17.

Seamless mobility between networks in a packet-switched environment, such as an Internet Protocol (IP) environment, is defined by Mobile IP. A version of Mobile IP (Mobile IPv6) is described in Internet Engineering Task Force (IETF) Internet Draft, entitled “IP Mobility Support in IPv6, draft-ietf-mobileip-ipv6-24.txt,” dated June 2003, or RFC 3775, entitled “Mobility Support for IPv6,” dated June 2004. As used here, the term “Mobile IP” or “Mobile IPv6” refers to the Mobile IPv6 as well as any subsequent Mobile IP protocol that evolves from or is derived from the Mobile IPv6 protocol. One version of IP is IPv4, described in RFC 791, entitled “Internet Protocol,” dated September 1981; while another version of IP is IPv6, described in RFC 2460, entitled “Internet Protocol, Version 6 (IPv6) Specification,” dated December 1998. In packet-switched communications, packets or other units of data carry routing information (in the form of network addresses) that are used to route the packets or data units over one or more paths to a destination endpoint. However, note that some embodiments can be applied in networks using other packet-switched protocols and mobility protocols.

For communicating circuit-switched voice or other traffic, the radio network 14 or 44 is coupled to a respective mobile switching center (MSC) 18 or 46, which is responsible for switching mobile station-originated or mobile station-terminated traffic. Effectively, the MSC 18 or 46 is the interface for signaling end user traffic between the wireless network 10 or 12 and public switched networks, such as a public switched telephone network (PSTN) 20, or other MSCs. The PSTN 20 is connected to landline terminals, such as telephones 22.

The wireless network 10 or 12 is also capable of supporting packet-switched data services, in which packet data is communicated between the mobile station and another endpoint, which can be a terminal coupled to a packet-based data network 24 or another mobile station that is capable of communicating packet data. Examples of the packet-based data network 24 include private networks (such as local area networks or wide area networks) and public networks (such as the Internet). Packet data is communicated in a packet-switched communications session established between the mobile station and the other endpoint.

To communicate packet data, the radio network 14 or 44 manages the relay of packets with a packet data serving node (PDSN) 26 or 42. With other types of wireless protocols, other types of entities are involved in communicating mobile station-originated or mobile station-terminated packet data. More generally, a node (such as the PDSN 26 or 42) in the wireless network that manages the communication of packet-data is referred to as a “packet service node.”

The PDSN 26 or 42 establishes, maintains, and terminates link layer sessions to mobile stations, and routes mobile station-originated or mobile station-terminated packet data traffic. The PDSN 26 or 42 is coupled to the packet-based data network 24, which is connected to various endpoints, such as a computer 28 or a network telephone 30. Examples of packet-switched communications include web browsing, electronic mail, text chat sessions, file transfers, interactive game sessions, voice-over-IP (Internet Protocol) sessions, and so forth. In one embodiment, packet-switched communications utilize a connectionless internetwork layer defined by IP.

To authenticate a mobile node in a mobile network (e.g., wireless network 10 or 12) according to Mobile IPv6, a lightweight protocol according to some embodiments is implemented. This lightweight protocol is less processing intensive than the IP Security (Ipsec) protocol that is conventionally used for authenticating a mobile node. The lightweight protocol enables authentication of the mobile node to be performed by inserting an authentication information element into registration messages that already have to be exchanged between a mobile node and a home agent 40 to register the mobile node. The authentication information element allows the home agent to authenticate the mobile node. In addition to the authentication information element, a network access identifier (NAI) information element and a replay attack protection information element can also be included in the registration messages.

When a mobile node first starts up in a mobile network, the mobile node performs a registration procedure with a home agent (e.g., 40). The home agent 40, in one implementation, is part of the PDSN 40. Alternatively, the home agent 40 can be a separate component. Note also that a foreign agent 64 is provided in the PDSN 26 of the visited network 10.

As part of the registration procedure according to Mobile IPv6, the mobile node sends a Binding Update message to its home agent. In accordance with some embodiments, additional information elements provided in the Binding Update message include: (1) a network access identifier (NAI) of the mobile node, (2) authentication information to enable authentication of the mobile node by the home agent, and (3) identifier (ID) mobility information to be used for replay attack protection. Replay attack refers to an attack in which a hacker monitors packets over a network to copy information from the packets so that the hacker can gain unauthorized access to the network.

These additional information elements of the Binding Update message are referred to as an MN-NAI Mobility Option (for storing the NAI of the mobile node), an Authentication Mobility Option (for storing the authentication information), and an ID Mobility Option (for storing ID information). The Authentication, MN-NAI, and ID Mobility Options are part of the mobility header of the Binding Update message. The mobility header is an extension header used by mobile nodes, home agents, and other nodes in messaging related to the creation and management of bindings.

By including the NAI in the Binding Update message, the home agent is able to use the NAI, along with the authentication information element, to perform an authentication procedure with an Authentication, Authorization, and Accounting (AAA) server for authenticating the mobile node. Also, the NAI element allows the mobile node to obtain a new home IP address. Such a mechanism is useful when the mobile node has established a PPP (Point-to-Point Protocol) session while the mobile node does not yet have a home IP address. PPP is described in RFC 1661, entitled “The Point-to-Point Protocol (PPP),” dated July 1994. The mechanism can also be used when the mobile node is changing its home IP address, either because of renumbering of it home network or because the mobile node periodically changes IP addresses.

The ID Mobility Option contains either a timestamp or a nonce (a random number or a combination of a random number and timestamp) for replay attack protection. For example, if a timestamp is included, then a home agent would be able to discard messages during a replay attack that are determined to be too old based on a comparison of a current time with the timestamp contained in the ID Mobility Option.

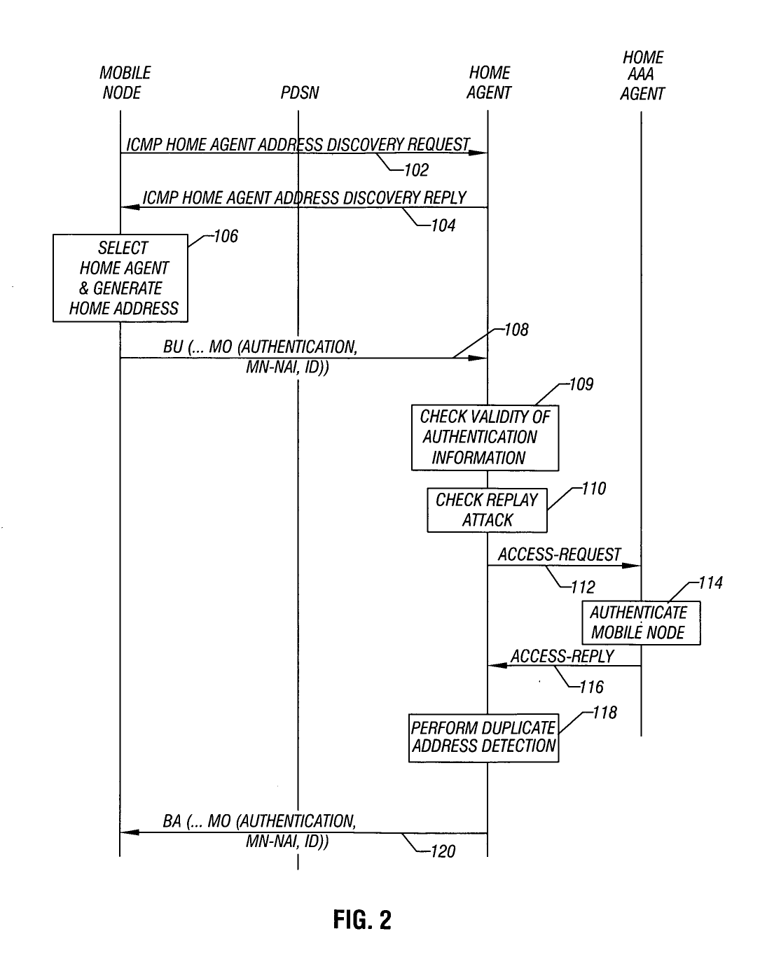

FIG. 2 shows a message flow diagram of a process of authenticating a mobile node by a home agent, in accordance with an embodiment. The mobile node can be mobile station 16 (FIG. 1), mobile station 17, or any other mobile node. Initially, when the mobile node first starts up, the mobile node sends (at 102) an ICMP (Internet Control Message Protocol) Home Agent Address Discovery Request through a PDSN to the packet data network. Note that the PDSN acts as a router in this case. ICMP is described by RFC 792, entitled “Internet Control Message Protocol,” dated September 1981. The ICMP Home Agent Address Discovery Request is received by the home agent (e.g., 40 in FIG. 1) or by any other designated router within the visited network 10 (as configured by the visited network operator), which responds (at 104) with an ICMP Home Agent Address Discovery Reply message. The reply message contains a list of all available home agents. Upon receipt of the list of home agents, the mobile node selects (at 106) the home agent from the list, and optionally generates a home IP address of the mobile node based on information from the home agent. Selection of the home agent can be based on various criteria, such as an order of the home agents in the list. Alternatively, the home IP address of the mobile node can be assigned later.

The mobile node then sends a Binding Update message (at 108) to the selected home agent. The Binding Update message contains the Authentication, MN-NAI, and ID Mobility Options, in accordance with some embodiments. The remaining content of the Binding Update message includes a home IP address field (to carry the home address of the mobile node) and other information elements as defined by the IPv6 specification, according to one implementation.

In some cases, the mobile node may send a zero value in the home IP address field of the Binding Update message. In response to this, the home agent allocates a unique home IP address for the mobile node based on the NAI contained in the Binding Update message.

Upon receiving the Binding Update message, the home agent checks (at 109) the validity of an Authenticator field (described in connection with FIG. 5) in the Authentication Mobility Option of the Binding Update message. The validity is based on a shared secret key contained in the Authenticator field. Next, the home agent checks (at 110) for a replay attack using the ID field in the ID Mobility Option of the Binding Update message. The home agent checks to ensure that the timestamp is not different from that current time by more than a predetermined time period (e.g., 500 milliseconds). If the timestamp check indicates that the current time is greater than the timestamp by the predetermined amount, then the home agent indicates an error has occurred by sending back a Binding Acknowledgment message with an error code. In response to this error, the mobile node may update the ID field value in a subsequent Binding Update message.

Assuming that the check indicates that the Binding Update message is not part of a replay attack, the home agent sends (at 112) an Access-Request to a home Authentication, Authorization, and Accounting (AAA) server 38 (FIG. 1). Note that a foreign AAA server 66 is provided in the visited network 10. The home AAA server 38 provides authentication and authorization services for a mobile node that is attempting to connect to a home network. The authentication and authorization services provided by the home AAA server 38 are based on the NAI of the mobile node and information in the Authentication Mobility Option. In this case, the NAI that is communicated in the Access-Request message is the NAI extracted from the Binding Update message. The Access-Request message also includes the Authenticator field extracted from the Authentication Mobility Option in the Binding Update message. Mobile IP AAA is described in RFC 2977, entitled “Mobile IP Authentication, Authorization, and Accounting Requirements,” dated October 2000. The Access-Request message is according to a RADIUS (Remote Authentication Dial In User Service) protocol, as described in RFC 2138, dated April 1997. However, in other embodiments, other forms of messages can be employed between the home agent and the home AAA server.

In response to the Access-Request message, the home AAA server authenticates (at 114) the mobile node and sends back (at 116) an Access-Accept message (also a RADIUS message according to one implementation) to indicate successful authentication. Note that the authentication performed by the AAA server is based on the NAI of the MN-NAI Mobility Option as well as on authentication information in the Authentication Mobility Option of the Binding Update message.

The home agent then performs (at 118) duplicate address detection for the home address communicated in the Binding Update message to detect if a duplicate address has been assigned. If the duplicate address detection has been successfully performed, the home agent sends back (at 120) a Binding Acknowledgment message which essentially contains much of the same information as in the Binding Update message. In particular, according to some embodiments, the Binding Acknowledgment message contains the MN-NAI Mobility Option, Authentication Mobility Option, and the ID Mobility Option that were communicated in the Binding Update message. The Binding Acknowledgment message also contains a home IP address field to carry the home IP address of the mobile node. Note that the ID Mobility Option in the Binding Acknowledgment message can be used by the mobile node to protect against a replay attack.

The tasks of FIG. 2 performed by the mobile node can be implemented in a mobile IP layer 50 (FIG. 1) and/or other software layers in the mobile node (e.g. mobile station 17 in FIG. 1). The mobile station 17 depicted in FIG. 1 also includes a radio interface 52 to communicate over a radio link with the radio network 44. The software layers of the mobile station 17 are executable on a central processing unit (CPU) 54. Data and instructions in the mobile station 17 can be stored in a storage 56.

Similarly, the tasks of FIG. 2 performed by the home agent can also be performed in a Mobile IP layer 58 (FIG. 1) and/or other software layers. The software layers of the home agent are executable on a CPU 60, and data and instructions can be storage 62.

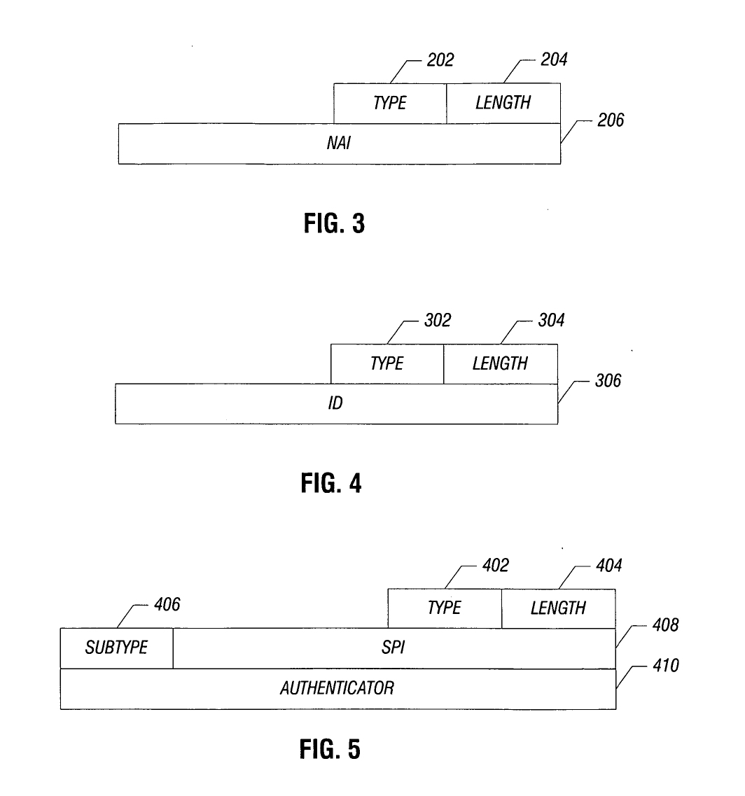

FIG. 3 illustrates an example format of the MN-NAI Mobility Option contained in the Binding Update or Binding Acknowledgment message. The MN-NAI Mobility Option contains a Type field 202 to indicate the type of option, and a Length field 204 to indicate the length of the NAI that is contained in an NAI field 206. An example of an NAI is user1@nortelnetworks.com. Note that the NAI of the mobile node is different from the IP address of the mobile node.

As shown in FIG. 4, the ID Mobility Option of the Binding Update or Binding Acknowledgment message contains a Type field 302, a Length field 304, and an ID field 306 that contains either a nonce or a timestamp.

The Authentication Mobility Option is depicted in FIG. 5. This option contains a Type field 402, a Length field 404 to indicate the length of a Subtype field 406, SPI field 408, and Authenticator field 410 (combined). The Subtype field 406 is a number assigned to identify the entity and/or mechanism to be used to authenticate the message. The SPI field 408 is used to identify the particular security association to use to authenticate the message. The Authenticator field 410 contains the information to authenticate the mobile node. In one implementation, the Authentication Mobility Option is the last option in a message that contains a mobility header.

The Authenticator field 410 contains the following information:
Authenticator=First (96, HMAC_SHA1 (MN-HA Shared Key, Mobility Data)).

Basically, the Authenticator field 410 contains the first 96 bits of a hash function (defined by HMAC_SHA1) of the following two data elements: MN-HA Shared Key, Mobility Data. The hash function is a one-way hash function, such as SHA-1 (secure hash algorithm-1) to enable secure communication of the shared key. The MN-HA Shared Key is the shared secret key between the mobile node and the home agent. If the home agent does not have a copy of this shared key, the home agent can access the home AAA server 38 (FIG. 1) to retrieve the key to perform authentication operations.

The Mobility Data contained in the Authenticator field is defined as follows:
Mobility Data=care-of address|home address|MH Data|SPI.

The care-of address is the IP address (in a visited network) to which packets addressed to a mobile node's home address are routed. The home address is the IP address of the mobile node in the home network. The MH Data contains information in the mobility header of the Binding Update message. The SPI is from the SPI field 408 of the Authentication Mobility Option (FIG. 5).

Upon receiving a Binding Update message (108 in FIG. 2) from the mobile node, the home agent extracts the content of the Authenticator field 410 and SPI field 408 from the Authentication Mobility Option (FIG. 5). The home agent also extracts the NAI from the NAI field 206 of the MN-NAI Mobility Option (FIG. 3). The NAI, Authenticator and SPI values are included in the Access-Request (or other type of message) sent by the home agent to the AAA server.

By using the lightweight authentication mechanism according to some embodiments, a more efficient authentication procedure than those offered by conventional mechanisms, such as IPsec, is provided. For example, the relatively lengthy session setup time for IPsec can be avoided by use of the lightweight authentication mechanism according to some embodiments. Also, the lightweight authentication mechanism allows for more efficient usage of processing resources of mobile nodes.

The tasks performed by the home agent (or other equivalent entity in a home network) and mobile station are provided by software in the home agent and mobile station. Instructions of such software routines or modules are stored on one or more storage devices in the corresponding systems and loaded for execution on corresponding processors. The processors include microprocessors, microcontrollers, processor modules or subsystems (including one or more microprocessors or microcontrollers), or other control or computing devices. As used here, a “controller” refers to hardware, software, or a combination thereof. A “controller” can refer to a single component or to plural components (whether software or hardware).

Data and instructions (of the software) are stored in respective storage devices, which are implemented as one or more machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

The instructions of the software are loaded or transported to each entity in one of many different ways. For example, code segments including instructions stored on floppy disks, CD or DVD media, a hard disk, or transported through a network interface card, modem, or other interface device are loaded into the entity and executed as corresponding software routines or modules. In the loading or transport process, data signals that are embodied in carrier waves (transmitted over telephone lines, network lines, wireless links, cables, and the like) communicate the code segments, including instructions, to the entity. Such carrier waves are in the form of electrical, optical, acoustical, electromagnetic, or other types of signals.

While some embodiments have been disclosed with respect to a limited number of embodiments, those skilled in the art will appreciate numerous modifications and variations there from. It is intended that the appended claims cover such modifications and variations as fall within the true spirit and scope of the invention.

1. A method of authenticating a mobile node, comprising:
receiving, from the mobile node, a Mobile IPv6 registration request, the registration request containing authentication information;
performing a procedure to authenticate the mobile node based on the authentication information contained in the Mobile IPv6 registration request; and
sending a reply to the mobile node acknowledging successful registration.

2. The method of claim 1, wherein receiving the Mobile IPv6 registration request containing the authentication information comprises receiving the Mobile IPv6 registration request containing authentication information that is different from Internet Protocol Security information.

3. The method of claim 1, wherein receiving the Mobile IPv6 registration request comprises receiving a Mobile IPv6 registration request that contains the authentication information and a network access identifier.

4. The method of claim 3, wherein receiving the Mobile IPv6 registration request comprises receiving a Mobile IPv6 registration request that contains the authentication information, network access identifier, and a replay protection field, the method further comprises:
checking for a replay attack based on the replay protection field.

5. The method of claim 4, wherein the replay protection field contains at least one of a timestamp and a nonce, wherein checking for the replay attack is based on the at least one of the timestamp and nonce.

6. The method of claim 1, wherein receiving the Mobile IPv6 registration request comprises receiving a Mobile IPv6 Binding Update message.

7. The method of claim 5, wherein sending the reply to the mobile node comprises sending a Mobile IPv6 Binding Acknowledgment message, the Binding Acknowledgment message containing the authentication information.

8. The method of claim 7, further comprising adding the authentication information, a network access identifier, and a replay protection field to the Binding Acknowledgment message.

9. The method of claim 8, wherein the replay protection field comprises at least one of a timestamp and a nonce to enable checking for a reply attack by the mobile node.

10. The method of claim 7, wherein the authentication information includes a Security Parameter Index value and an Authenticator value, the Authenticator value containing at least a portion of a value derived by hashing information containing at least a secret key shared between the mobile node and a home agent.

11. The method of claim 1, further comprising:
extracting the authentication information from the Mobile IPv6 registration request; and
in response to the Mobile IPv6 registration request, sending a message to an Authentication, Authorization and Accounting (AAA) server to perform the authentication procedure.

12. The method of claim 1, wherein the authentication information includes a Security Parameter Index value and an Authenticator value, the Authenticator value containing at least a portion of a value derived by hashing information containing at least a secret key shared between the mobile node and a home agent.

13. An article comprising at least one storage medium containing instructions that when executed cause a system in a mobile network to:
receive a Mobile IPv6 registration message, the registration message containing authentication information used to authenticate a mobile node in the mobile network.

14. The article of claim 13, wherein the authentication information is different from Internet Protocol Security information.

15. The article of claim 13, wherein the system comprises a mobile station, wherein the instructions when executed cause the mobile station to receive a Mobile IPv6 Binding Acknowledgment message that contains the authentication information.

16. The article of claim 15, wherein receiving the Mobile IPv6 Binding Acknowledgment message comprises receiving a Mobile IPv6 Binding Acknowledgment message that contains the authentication information and a network access identifier of the mobile node.

17. The article of claim 13, wherein the system comprises a home agent, wherein the instructions when executed cause the home agent to receive a Mobile IPv6 Binding Update message, the Mobile IPv6 Binding Update message containing the authentication information.

18. The article of claim 17, wherein the instructions when executed cause the home agent to further send an access request to an Authentication, Authorization, Accounting server to perform an authentication procedure, wherein the message sent to the AAA server contains the authentication information in the Mobile IPv6 Binding Update message.

19. The article of claim 13, wherein the Mobile IPv6 registration message further contains a replay protection field, wherein the instructions when executed cause the system to further detect for a replay attack using the replay protection field in the Mobile IPv6 registration message.

20. The article of claim 13, wherein receiving the Mobile IPv6 registration message comprises receiving a Mobile IPv6 registration message that further contains a network access identifier of the mobile node.

21. The article of claim 13, wherein the authentication information contains a Security Parameter Index value and an Authenticator value, where the Authenticator value contains at least a portion of a value derived from hashing information containing at least a secret shared key between a mobile node and a home agent.

22. A mobile node comprising:
an interface to communicate with a mobile network that contains a home agent; and
a controller to:
send a Binding Update message to the home agent, wherein the Binding Update message contains an authentication field to enable the home agent to authenticate the mobile node; and
receive a Binding Acknowledgment message from the home agent, wherein the Binding Acknowledgment message indicates that the mobile node has been successfully authenticated by the home agent.

23. The mobile node of claim 22, wherein the Binding Update message further contains a network access identifier of the mobile node.

24. The mobile node of claim 23, wherein the Binding Update message further contains a replay attack protection field.

25. The mobile node of claim 22, wherein the authentication field contains information different from Internet Protocol Security information.

26. The mobile node of claim 25, wherein the Binding Update message comprises a Mobile IPv6 Binding Update message.
